(19) United States
(12) Patent Application Publication
(10) Pub. No.: US 2025/0166140 A1
(43) Pub. Date: May 22, 2025

(54) IMAGE INPAINTING METHOD AND DEVICE

(71) Applicant: Beijing Zitiao Network Technology Co., Ltd., Haidian District, Beijing (CN)

(72) Inventors: Zidong ZHONG, Beijing (CN); Qianqian WANG, Beijing (CN); Shiyin WANG, Beijing (CN)

(21) Appl. No.: 18/727,057

(22) PCT Filed: Jan. 4, 2023
(86) PCT No.: PCT/CN2023/070461

§ 371 Date: Jul. 5, 2024

(30) Foreign Application Priority Data
Jan. 6, 2022 (CN) 202210009011.0

(51) Int. Cl. G06T 5/77; G06T 5/50; G06V 10/25

(52) U.S. Cl. CPC G06T 5/77; G06T 5/50; G06V 10/25; G06T 2207/20221

(57) ABSTRACT

Embodiments of the present disclosure relate to the technical field of image processing, and provide an image inpainting method and device. The method includes: obtaining an image to be inpainted; determining an object area and a scratch area of the image to be inpainted, wherein the object area is an area where a target object in the image to be inpainted is located; determining an object scratch area and a background scratch area according to the object area and the scratch area; performing image inpainting on the object area according to the object scratch area to obtain an object image; performing image inpainting on the image, to be inpainted, according to the background scratch area to obtain a background image; and fusing the object image and the background image to obtain an inpainted image of the image to be inpainted.

### CROSS-REFERENCE TO RELATED APPLICATIONS

This application is a U.S. National Stage under 35 U.S.C. § 371 of International Application No. PCT/CN2023/070461 filed on Jan. 4, 2023, which is based on and claims the priority of the application with Chinese application number 202210009011.0, filed on Jan. 6, 2022. The disclosures of each of these applications are hereby incorporated into this application in their entireties.

### TECHNICAL FIELD

The present disclosure relates to the field of image processing technology, and in particular, to an image inpainting method and apparatus.

### BACKGROUND

Due to factors such as age and improper storage, many photos will have problems such as yellowing, noise, scratches, and stains. Such photos often entrust a lot of people's emotions, so inpainting of such photos is of great significance.

### SUMMARY

Embodiments of the present disclosure provide an image inpainting method and apparatus.

Some embodiments of the present disclosure provide technical solutions as follows:

In a first aspect, an embodiment of the present disclosure provides an image inpainting method, comprising:
obtaining an image to be inpainted;
determining an object region and a scratch region of the image to be inpainted, the object region being a region where a target object in the image to be inpainted is located;
determining an object scratch region and a background scratch region according to the object region and the scratch region;
performing image inpainting on the object region according to the object scratch region to obtain an object image;
performing image inpainting on the image to be inpainted according to the background scratch region to obtain a background image; and
fusing the object image and the background image to obtain an inpainted image of the image to be inpainted.

As an implementation of the embodiment of the present disclosure, the determining an object scratch region and a background scratch region according to the object region and the scratch region includes:
obtaining the object scratch region based on a segmentation network model and the object region, the segmentation network model being a network model obtained by training a U-Net (UNET) based on first sample data, the first sample data including a plurality of sample images containing the target object and scratch regions corresponding to individual sample images; and
determining the background scratch region according to the scratch region and the object scratch region.

As an implementation of the embodiment of the present disclosure, the performing image inpainting on the object region according to the object scratch region to obtaining an object image includes:
inputting the object scratch region and the object region into a first image inpainting network model, and obtaining output of the first image inpainting network model as the object image;
wherein, the first image inpainting network model is a network model obtained by training a first network model based on second sample data, the second sample data including a plurality of sample object images with scratches and scratch-free images corresponding to individual sample object images.

As an implementation of the embodiment of the present disclosure, the performing image inpainting on the image to be inpainted according to the background scratch region to obtain a background image includes:
inputting the background scratch region and the image to be inpainted into a second image inpainting network model, and obtaining output of the second image inpainting network model as the background image;
wherein, the second image inpainting network model is a network model obtained by training a second network model based on third sample data, the third sample data including a plurality of sample images with scratches and scratch-free images corresponding to individual sample images.

As an implementation of the embodiment of the present disclosure, after determining an object region and a scratch region of the image to be inpainted, the method further comprises:
determining whether the area of each scratch region is greater than or equal to a threshold area; and
deleting scratch regions with an area smaller than the threshold area from scratch regions of the image to be inpainted.

As an implementation of the embodiment of the present disclosure, before segmenting the scratch region into an object scratch region and a background scratch region according to the object region, the method further comprises:
detecting whether the image to be inpainted is a color image;
in response to the image to be inpainted being not a color image, coloring the image to be inpainted.

As an implementation of the embodiment of the present disclosure, after coloring the image to be inpainted, the method further comprises:
determining an optimization region of the image to be inpainted, the optimization region being a region composed of pixels in the image to be inpainted whose color values fall within a preset color range; and
performing optimization on the optimization region based on a preset optimization algorithm.

As an implementation of the embodiment of the present disclosure, after coloring the image to be inpainted, the method further comprises:
performing white balance processing on the image to be inpainted based on a perfect reflector algorithm.

As an implementation of the embodiment of the present disclosure, after coloring the image to be inpainted, the method further comprises:
adjusting the contrast of the image to be inpainted based on a high dynamic range imaging network model (HDRNET).

As an implementation of the embodiment of the present disclosure, before fusing the object image and the background image to obtain an inpainted image of the image to be inpainted, the method further comprises:
performing deblurring processing on the object image and the background image, respectively.

In a second aspect, an embodiment of the present disclosure provides an image inpainting apparatus, comprising:
an obtaining unit configured to obtain an image to be inpainted;
a detection unit configured to determine an object region and a scratch region of the image to be inpainted;
a determination unit configured to determine an object scratch region and a background scratch region according to the object region and the scratch region;
an inpainting unit configured to perform image inpainting on the object region according to the object scratch region to obtain an object image;
the inpainting unit being further configured to perform image inpainting on the image to be inpainted according to the background scratch region to obtain a background image;
a fusion unit configured to fuse the object image and the background image to obtain an inpainted image of the image to be inpainted.

As an implementation of the embodiment of the present disclosure, the determination unit is specifically configured to obtain the object scratch region based on a segmentation network model and the object region, the segmentation network model being a network model obtained by training a U-Net (UNET) based on a first sample data, the first sample data including a plurality of sample images containing the target object and scratch regions corresponding to individual sample images; and determine the background scratch region according to the scratch region and the object scratch region.

As an implementation of the embodiment of the present disclosure, the inpainting unit is specifically configured to input the object scratch region and the object region into a first image inpainting network model, and obtain output of the first image inpainting network model as the object image;
wherein, the first image inpainting network model is a network model obtained by training a first network model based on a second sample data, the second sample data including a plurality of sample object images with scratches and scratch-free images corresponding to individual sample object images.

As an implementation of the embodiment of the present disclosure, the inpainting unit is specifically configured to input the background scratch region and the image to be inpainted into a second image inpainting network model, and obtain output of the second image inpainting network model as the background image;
wherein, the second image inpainting network model is a network model obtained by training a second network model based on a third sample data, the third sample data including a plurality of sample images with scratches and scratch-free images corresponding to individual sample images.

As an implementation of the embodiment of the present disclosure, the detection unit is further configured to, after determining an object region and a scratch region of the image to be inpainted, determine whether the area of each scratch region is greater than or equal to a threshold area; and delete scratch regions with an area smaller than the threshold area from scratch regions of the image to be inpainted.

As an implementation of the embodiment of the present disclosure,
the detection unit is further configured to, before segmenting the scratch region into an object scratch region and a background scratch region according to the object region, detect whether the image to be inpainted is a color image;
the inpainting unit is further configured to color the image to be inpainted in response to the image to be inpainted being not a color image.

As an implementation of the embodiment of the present disclosure,
the detection unit is further configured to, after coloring the image to be inpainted, determine an optimization region of the image to be inpainted, the optimization region being a region composed of pixels in the image to be inpainted whose color values fall within a preset color range;
the inpainting unit is further configured to perform optimization on the optimization region based on a preset optimization algorithm.

As an implementation of the embodiment of the present disclosure, the inpainting unit is further configured to, after coloring the image to be inpainted, perform white balance processing on the image to be inpainted based on a perfect reflector algorithm.

As an implementation of the embodiment of the present disclosure, the inpainting unit is further configured to, after coloring the image to be inpainted, adjust the contrast of the image to be inpainted based on a high dynamic range imaging network model (HDRNET).

As an implementation of the embodiment of the present disclosure, the inpainting unit is further configured to, before fusing the object image and the background image to obtain an inpainted image of the image to be inpainted, perform deblurring processing on the object image and the background image, respectively.

In a third aspect, an embodiment of the present disclosure provides an electronic device, comprising: a memory and a processor, wherein the memory is configured to store a computer program; the processor is configured to, when executing the computer program, cause the electronic device to implement the image inpainting method of any of the above implementations.

In a fourth aspect, an embodiment of the present disclosure provides a computer-readable storage medium, which, when the computer program is executed by a computing device, causes the computing device to implement the image inpainting method of any of the above implementations.

In a fifth aspect, an embodiment of the present disclosure provides a computer program product, which, when run on a computer, causes the computer to implement the image inpainting method of any of the above implementations.

### BRIEF DESCRIPTION OF THE DRAWINGS

The accompanying drawings, which are incorporated in and constitute a part of this specification, illustrate embodiments consistent with the disclosure and serve to explain the principles of the disclosure together with the description.

In order to more clearly illustrate technical solutions in the embodiments of the present disclosure or the related art, the accompanying drawings that need to be used in the description of the embodiments or the related art will be introduced briefly follow. Apparently, for those of ordinary skilled in the art, other drawings can also be obtained from these drawings without any creative effort.

FIG. 1 is one of flow charts of steps of an image inpainting method provided by an embodiment of the present disclosure;

FIG. 2 is a scene interface diagram of the image inpainting method provided by an embodiment of the present disclosure;

FIG. 3 is a schematic diagram of a scratch region provided by an embodiment of the present disclosure;

FIG. 4 is a schematic diagram of a U-NET provided by an embodiment of the present disclosure;

FIG. 5 is another flow chart of steps of an image inpainting method provided by an embodiment of the present disclosure;

FIG. 6 is an architecture diagram of an image inpainting method provided by an embodiment of the present disclosure;

FIG. 7 is a schematic structural diagram of an image inpainting apparatus provided by an embodiment of the present disclosure;

FIG. 8 is a schematic diagram of a hardware structure of an electronic device provided by an embodiment of the present disclosure.

### DETAILED DESCRIPTION

In order to understand the above objects, features and advantages of the present disclosure more clearly, the solution of the present disclosure will be further described below. It should be noted that the embodiments of the present disclosure and the features in the embodiments can be combined with each other as long as there is no conflict.

Many specific details are set forth in the following description to fully understand the present disclosure, but the present disclosure can also be implemented in other ways different from those described herein; obviously, the embodiments in the specification are only a part, not all, of embodiments of the present disclosure.

In the embodiments of the present disclosure, words such as “exemplary” or “for example” are used to represent serving as an example, exemplification or illustration. Any embodiment or design solutions described as “exemplary” or “for example” in the embodiments of the disclosure should not be construed as preferred or advantageous over other embodiments or design solutions. More exactly, the use of words such as “exemplary” or “for example” is intended to present related concepts in a specific manner. In addition, in the description of the embodiments of the present disclosure, the meaning of “a plurality of” refers to two or more, unless otherwise specified.

Relatively long-standing image materials, such as some classic image materials (photos, videos, portraits), often carry people's memories of an era. Through these image materials, people can reminisce about their childhood, remember martyrs, relive classics, etc. However, due to reasons such as immature technology, poor storage environments, and improper preservation, image materials often suffer from scratches and local damage. Some users may repair image materials through manual inpainting, but manual inpainting is more expensive and less efficient. In related technologies, a commonly used method for scratch inpainting is to estimate the color value of each pixel in a scratch region according to the color values of undamaged regions around the scratch region. For example, the color value of each pixel in the scratch region is set to the average of the color values of the surrounding undamaged regions. However, since such methods cannot capture high-level semantics, it is difficult to generate realistic structures for images with non-repeating patterns, and the inpainting effect is poor.

In response to the above problems, embodiments of the present disclosure provide an image inpainting method and apparatus, aiming to provide image materials inpainting support for users and public welfare undertakings as much as possible.

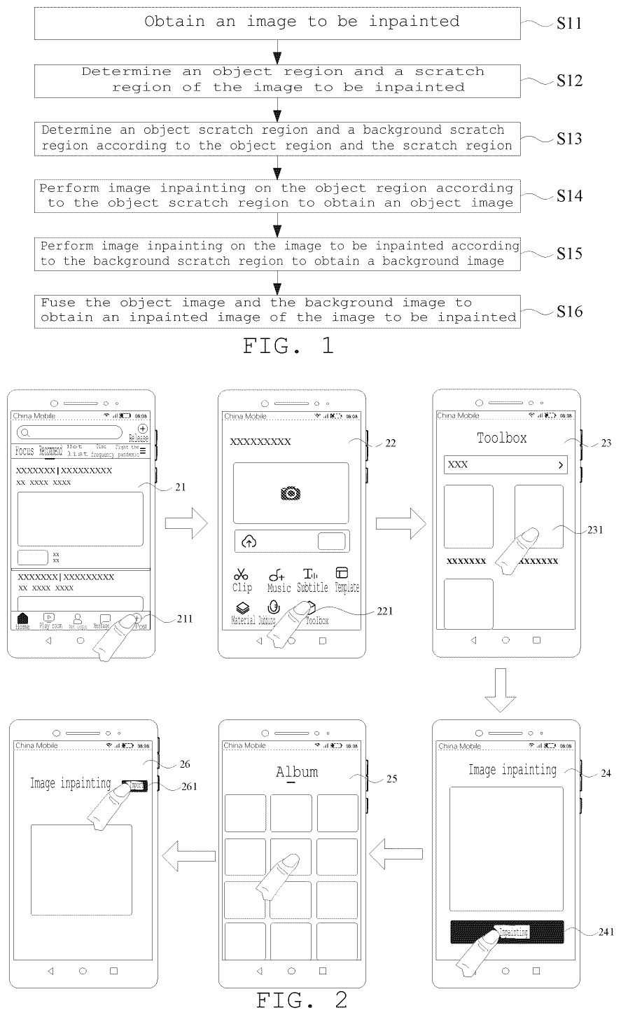

An embodiment of the present disclosure provides an image inpainting method. Referring to FIG. 1, the image inpainting method comprises the following steps S11 to S16:

S11. Obtaining an image to be inpainted.

As an implementation of the embodiment of the present disclosure, obtaining an image to be inpainted may include: receiving an image to be inpainted that is uploaded, imported, sent, or downloaded by a user.

Exemplarily, referring to FIG. 2, in some embodiments, an implementation process for obtaining an image to be inpainted may include: displaying a first control 211 for triggering releasing of an image or video in an initial interface 21 of an application program. When receiving input to the first control 211 by a user, the application program jumps to a content creation interface 22, which includes a second control 221 for triggering optimization processing for an images or video. When receiving input to the second control 221 by the user, the application program jumps to a processing method selection interface 23, which includes a third control 231 for triggering inpainting of an image. When receiving input to the third control 231 by the user, the application program jumps to an image inpainting interface 24, which includes a fourth control 241 for triggering selection of the image to be inpainted. When receiving input to the fourth control 241 by the user, the application program jumps to an image preview interface 25, which includes preview images of a plurality of locally stored images. When receiving a selection operation by the user on a preview image of a certain image in the image preview interface 25, the application program jumps to an image upload interface 26, which includes a fifth control 261 for triggering uploading of the selected image. When receiving an operation by the user on the fifth control 261, the selected image is determined as the image to be inpainted.

As an implementation of the embodiment of the present disclosure, obtaining an image to be inpainted may include: digitizing physical photos or images selected by a user through a digital device to obtain the image to be inpainted.

S12. Determining an object region and a scratch region of the image to be inpainted.

Wherein, the object region is a region where a target object in the image to be inpainted is located.

Exemplarily, a target object may be any object in an image, such as a car, a flower, a mouse, a fling bird, etc.; or it may be one or more parts of an object in an image, such as the head and tail.

In some embodiments, the implementation of determining an object region of the image to be inpainted may include: identifying an object of the image to be inpainted through key point recognition technology (for example, identifying a vehicle body in the image to be inpainted based on a vehicle body key point recognition model), labelling each object region of the image to be inpainted through a rectangular box, and determining the region within each rectangular box as the object region of the image to be inpainted.

In some embodiments, the implementation of determining a scratch region of the image to be inpainted may include: determining the scratch region of the image to be inpainted through a pre-trained scratch detection network model.

It should be noted that, in the embodiments of the present disclosure, the number of object regions and scratch regions of the image to be inpainted may be one or more.

S13. Determining an object scratch region and a background scratch region according to the object region and the scratch region.

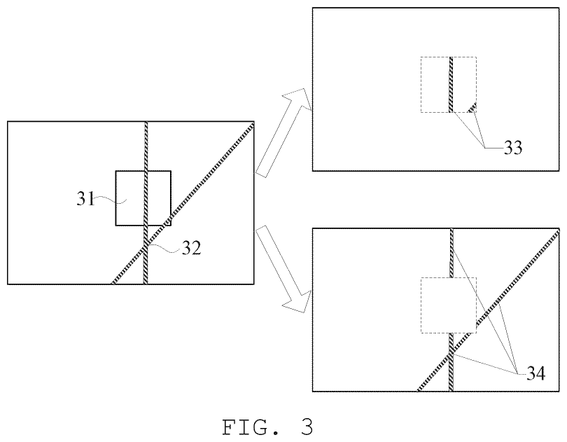

In the embodiment of the present disclosure, an object scratch region refers to the intersection of the scratch region and the object region, while the background scratch region refers to the difference between the scratch region and the object region. For example: as shown in FIG. 3, region 31 is an object region of the image to be inpainted, region 32 is a scratch region of the image to be inpainted, object scratch region 33 is the intersection of the region 31 and the region 32, and background scratch region 34 is the difference between the region 31 and the region 32.

As an implementation of the embodiment of the present disclosure, the implementation of the above step S13 (determining an object scratch region and a background scratch region according to the object region and the scratch region) includes the following steps a and b:

Step a. Obtaining the object scratch region based on a segmentation network model and the object region.

Wherein, the segmentation network model is a network model obtained by training a U-Net (UNET) based on first sample data, the first sample data including a plurality of sample images containing the target object and scratch regions corresponding to individual sample images.

Exemplarily, the implementation of obtaining first sample data may include: performing image acquisition of physical objects to obtain a plurality of object images, then generating scratch regions randomly for each object image, and superimposing each scratch region on the corresponding object image to generate a plurality of sample object images, and finally generating the first sample data according to each sample object image and the corresponding scratch regions.

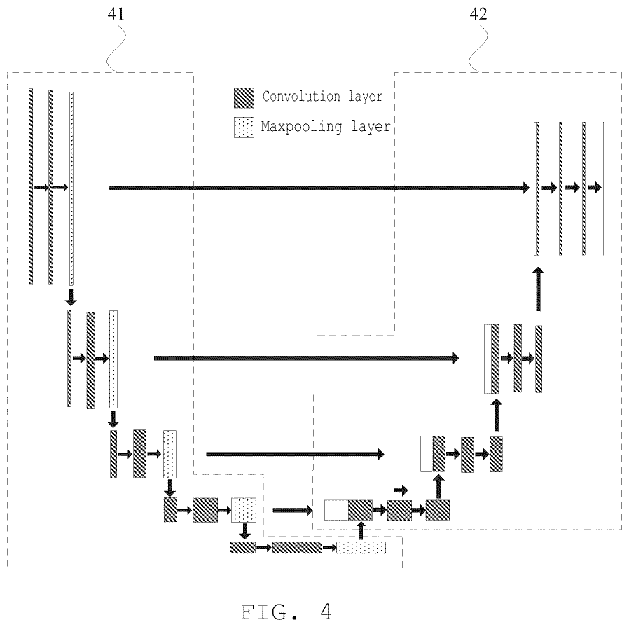

Specifically, as shown in FIG. 4, U-NET (UNET) is a special convolutional neural network. Since the structure of this special convolutional neural network is shaped like the letter U, it is named U-NET. The U-NET mainly consists of two parts: a contracting path 41 and an expanding path 42 that is symmetrical to the contracting path 41. Wherein, the contracting path 41 is mainly used to capture context information in an image, and the expanding path 42 is used to perform precise localization on parts that need to be segmented in the image. The contracting path 41 includes a plurality of encoding modules, each of which includes two unpadded convolutional layers and one Maxpooling layer; the expanding path 42 includes a plurality of decoding modules, and each of which includes three convolutional layers.

Step b: Determining the background scratch region according to the scratch region and the object scratch region.

In some embodiments, the object scratch region may be subtracted from the scratch region, and the remaining region in the scratch region may be determined as the background scratch region.

S14. Performing image inpainting on the object region according to the object scratch region to obtain an object image.

As an implementation of the embodiment of the present disclosure, the above step S14 (perform image inpainting on the object region according to the object scratch region to obtain an object image) includes:

inputting the object scratch region and the object region into a first image inpainting network model, and obtaining output of the first image inpainting network model as the object image;

wherein, the first image inpainting network model is a network model obtained by training a first network model based on second sample data, the second sample data including a plurality of sample object images and scratch-free images corresponding to individual sample object images.

That is, the object region and the object scratch region are sent to a pre-trained object inpainting network model, thereby performing scratch inpainting on the object region to obtain an inpainted object image.

Exemplarily, the implementation of obtaining second sample data may include: performing image acquisition of physical objects to obtain a plurality of object images, then generating scratch regions randomly for each object image, and superimposing each scratch region on the corresponding object image to generate a plurality of sample object images, and finally generating the second sample data according to each sample object image and the corresponding scratch-free images (object images with no scratch region superimposed).

S15. Performing image inpainting on the image to be inpainted according to the background scratch region to obtain a background image.

As an implementation of the embodiment of the present disclosure, the above step S15 (performing image inpainting on the image to be inpainted according to the background scratch region to obtain a background image) includes:
inputting the background scratch region and the image to be inpainted into a second image inpainting network model, and obtaining output of the second image inpainting network model as the background image;
wherein, the second image inpainting network model is a network model obtained by training a second network model based on third sample data, the third sample data including a plurality of sample images with scratches and scratch-free images corresponding to individual sample images.

That is, the entire image to be inpainted and the background scratch region are sent to a pre-trained image inpainting network model to perform scratch inpainting on the image to be inpainted to obtain an inpainted background image.

Exemplarily, the implementation of obtaining third sample data may include: performing image acquisition of any entity to obtain a plurality of images, then generating scratch regions randomly for each image, and superimposing each scratch region on the corresponding image to generate a plurality of sample images, and finally generating the third sample data according to each sample image and the corresponding scratch-free images (image with no scratch region superimposed).

S16. Fusing the object image and the background image to obtain an inpainted image of the image to be inpainted.

The image inpainting method and apparatus provided by the embodiments of the present disclosure can provide inpainting support for users, and especially provide technical support for providing in-depth public welfare inpainting for valuable videos and images.

Exemplarily, the object image and the background image can be superimposed according to position coordinates of the object image, thereby obtaining an inpainted image of the image to be inpainted.

It should be noted that the image inpainting method provided by the embodiment of the present disclosure may be achieved based on hardware of a terminal device and software installed on the terminal device, or it may be achieved by uploading an image to be inpainted to a server by a terminal device after obtaining the image to be inpainted, executing the above image inpainting method by the server to obtain an inpainted image of the image to be inpainted, and returning the image to be inpainted to the terminal device.

When inpainting an obtained image to be inpainted, the image inpainting method provided by the embodiment of the present disclosure first determines a scratch region of the image to be inpainted and an object region where a target object is located, then determines an object scratch region and a background scratch region according to the object region and the scratch region, and performs image inpainting on the object region according to the object scratch region to obtain an object image and performs image inpainting on the image to be inpainted according to the background scratch region to obtain a background image respectively, and finally fuses the object image and the background image to obtain an inpainted image of the image to be inpainted. Since the image inpainting method provided by the embodiment of the present disclosure can determine an object scratch region and a background scratch region according to the object region and the scratch region, and perform inpainting on an object region in the image to be inpainted and the image to be inpainted according to the object scratch region and the background scratch region respectively, the embodiment of the present disclosure may improve the inpainting effect of the image.

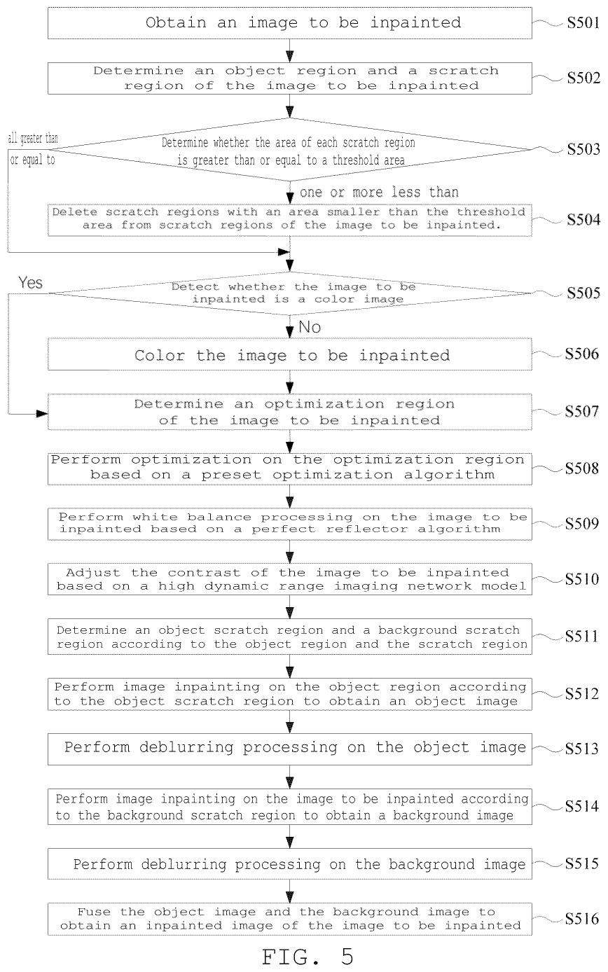

An embodiment of the present disclosure further provides another image inpainting method. Referring to FIG. 5, the image inpainting method comprises the following steps S501 to S516:

S501. Obtaining an image to be inpainted.

S502. Determining an object region and a scratch region of the image to be inpainted.

Wherein, the object region is a region where a target object in the image to be inpainted is located.

S503. Determining whether the area of each scratch region is greater than or equal to a threshold area.

In the above step S503, if the area of one or more scratch regions is smaller than the threshold area, the following step S504 is executed, and if the areas of all scratch regions are larger than the threshold area, the following step S504 is skipped and the following step S505 is executed directly.

S504. Deleting scratch regions with an area smaller than the threshold area from scratch regions of the image to be inpainted.

When determining a scratch region of the image to be inpainted, it is likely that a white region or a reflective region in the image to be inpainted may be determined as a scratch region mistakenly, which will lead to the white or reflective region being inpainted mistakenly as a scratch region. Considering that the area of a scratch region that affects visual effect of an image is generally large, and a scratch region with a smaller area has little impact on the visual effect of the image, therefore, in the above embodiment, the size of the area is determined on each scratch region, and scratch regions with an area smaller than a threshold area are deleted from scratch regions of the image to be inpainted, so as to avoid inpainting mistakenly a white region or reflective region in the image to be inpainted as a scratch region during the image inpainting process, thereby improving the quality of image inpainting.

S505. Detecting whether the image to be inpainted is a color image.

Specifically, in theory, the red component, blue component, and green component of the same pixel in a black and white image are all equal, while the red component, blue component, and green component of the same pixel in a color image can be different, so a plurality of pixels in the image to be inpainted may be chosen randomly, and it can be checked whether the differences among the red component, blue component and green component of each pixel are within a preset range; if so, it is determined that the image to be inpainted is a black and white image; if not, it is determined that the image to be inpainted is a color image.

In the above step S505, if it is determined that the image to be inpainted is not a color image (is a black and white image), the following step S506 is performed; if it is determined that the image to be inpainted is a color image, the following step S506 is skipped and the following step S507 is executed directly.

S506: Coloring the image to be inpainted.

Specifically, the image to be inpainted can be colored based on a Generative Adversarial Network (GAN).

In some embodiments, the implementation of coloring the image to be inpainted based on a Generative Adversarial Network may include:
constructing a generative adversarial network model first; inputting sample images to be colored into a generator of the generative adversarial network model for training, to obtain color images corresponding to individual sample images, and inputting noises that conform to a normal distribution into the generator of the generative adversarial network model for training, to obtain corresponding virtual images of the sample images; calculating the loss between the corresponding virtual images of the sample images and the color image samples corresponding to the sample images to obtain the loss result of the generator of the generative adversarial network model; updating parameters of the generator of the generative adversarial network model using a back propagation algorithm based on the loss result of the generator of the generative adversarial network model; inputting the color images corresponding to the sample images and the virtual images corresponding to the sample images into a discriminator of the generative adversarial network model for discrimination, to obtain the discriminant loss of the discriminator of the generative adversarial network model, and updating parameters of the discriminator of the generative adversarial network model using the back propagation algorithm based on the discriminant loss; and when the generative adversarial network model converges, determining the generative adversarial network model as a trained generative adversarial network, and coloring the image to be inpainted based on the trained generative adversarial network.

S507. Determining an optimization region of the image to be inpainted.

Wherein, the optimization region is a region composed of pixels in the image to be inpainted whose color values fall within a preset color range.

In some embodiments, the preset color range may be set in advance, and each pixel in the image to be inpainted is traversed, and pixels whose color value falls within the preset color range are determined, and finally the pixels whose color value falls within the preset color range are combined as the optimization region.

S508: Performing optimization on the optimization region based on a preset optimization algorithm.

Exemplarily, the preset optimization algorithm for performing optimization on the optimization region may include: smoothing the optimization region (skin grinding), texture enhancing for the optimization region, and color mapping for the optimization region, and so on.

S509. Performing white balance processing on the image to be inpainted based on a Perfect Reflector algorithm.

Specifically, the perfect reflector algorithm is also called the mirror algorithm. Its principle is: since a mirror can completely reflect light from a light source, if there is a mirror in an image to be inpainted, under a specific light source, obtained color information of the mirror may be considered as the information of the current light source. Under this theory, there must be a pure white pixel or a brightest pixel in an image to be inpainted, which, when adjusting the white balance of the image to be inpainted, is used as a reference to calibrate the brightness of each pixel in the image to be inpainted.

As an implementation of the embodiment of the present disclosure, the process of performing white balance processing on the image to be inpainted based on a perfect reflector algorithm may include: determining the maximum value of respective color channels of the image to be inpainted; determining a threshold that causes the number of white pixels to exceed a preset ratio of the total number of pixels; calculating the average value of respective color channels of pixel whose sum of color channels is greater than the threshold; and calculating the brightness of each pixel according to the maximum value of respective color channels and the average value of respective color channels.

S510. Adjusting the contrast of the image to be inpainted based on a high dynamic range imaging network model (High Dynamic Range Net, HDR Net).

As an implementation of the embodiment of the present disclosure, the implementation of adjusting the contrast of the image to be inpainted based on a high dynamic range imaging network model may include: obtaining a low-resolution image by downsampling a sample image, and setting a training label for the low-resolution image, obtaining affine transformation parameters of a bilateral grid by training on the low-resolution image and the label, and obtaining a contrast-adjusted image by performing operation on the image to be inpainted through the bilateral grid.

S511. Determining an object scratch region and a background scratch region according to the object region and the scratch region.

S512. Performing image inpainting on the object region according to the object scratch region to obtain an object image.

S513. Performing deblurring processing on the object image.

S514. Performing image inpainting on the image to be inpainted according to the background scratch region to obtain a background image.

S515. Performing deblurring processing on the background image.

Since the above embodiment may also perform deblurring processing on the object image and the background image respectively before fusing the object image and the background image, the above embodiment can reduce noise points in the object image and the background image, thereby improving the clarity of the finally generated inpainted image.

S516. Fusing the object image and the background image to obtain an inpainted image of the image to be inpainted.

Further, referring to FIG. 6, a system architecture for implementing the image inpainting method shown in FIG. 5 comprises: a detection module 61, a color inpainting module 62, a contrast adjustment module 63, a scratch inpainting module 64, a deblurring module 65 and a fusion module 66.

Wherein, the detection module 61 includes: an object detection unit 611, a scratch detection unit 612 and a color detection unit 613. The object detection unit 611 is used to determine an object region I_{target} of the image to be inpainted Iₘₐₚ; the scratch detection unit 612 is used to determine a scratch region I_{crease} of the image to be inpainted Iₘₐₚ; and the color detection unit 613 is used to determine whether the image to be inpainted Iₘₐₚ is a color image.

The color inpainting module 62 includes: a coloring unit 621 and a color optimization unit 622. The coloring unit 621 is used to color the image to be inpainted Iₘₐₚ when the detection module 61 determines that the image to be inpainted Iₘₐₚ is not a color image; the color optimization unit 622 is used to perform optimization process on an optimization region in the image to be inpainted Iₘₐₚ when the detection module 61 determines that the image to be inpainted Iₘₐₚ is a color image, and perform optimization process on the optimization region in the colored image to be inpainted when the detection module 61 determines that the image to be inpainted Iₘₐₚ is not a color image.

The contrast adjustment module 63 includes: a white balance unit 631 and a contrast unit 632. The white balance unit 631 is used to perform white balance processing on the image to be inpainted based on a perfect reflector algorithm; the contrast unit 632 is used to adjust the contrast of the image to be inpainted based on a high dynamic range imaging network model.

The scratch inpainting module 64 includes: a scratch determination unit 641, an object inpainting unit 642 and a background inpainting unit 643. The scratch determination unit 641 is used to segment the scratch region I_{crease} into an object scratch region I_{crease_target} and a background scratch region I_{crease_bg} according to the object region I_{target}. The object inpainting unit 642 is used to perform image inpainting on the object region I_{target} according to the object scratch region I_{crease_target} to obtain an object image O_{target}. The background inpainting unit 642 is used to perform image inpainting on the image to be inpainted Iₘₐₚ according to the background scratch region I_{crease_bg} to obtain a background image O_{bg}.

The deblurring module 65 includes: an object deblurring unit 651 and a background deblurring unit 652. The object deblurring unit 651 is used to perform deblurring processing on the object image O_{target}, and the background deblurring unit 652 is used to perform deblurring processing on the background image O_{bg}.

The fusion module 66 is used to fuse the deblurred object image and the deblurred background image to obtain an inpainted image Oₘₐₚ of the image to be inpainted Iₘₐₚ.

Based on the same inventive concept, as an implementation of the above method, an embodiment of the present disclosure further provides an image inpainting apparatus, which corresponds to the foregoing method embodiment. For ease of reading, this embodiment will not repeat the details in the foregoing method embodiments one by one, but it should be clear that the image inpainting apparatus in this embodiment can correspondingly implement all the contents in the foregoing method embodiments.

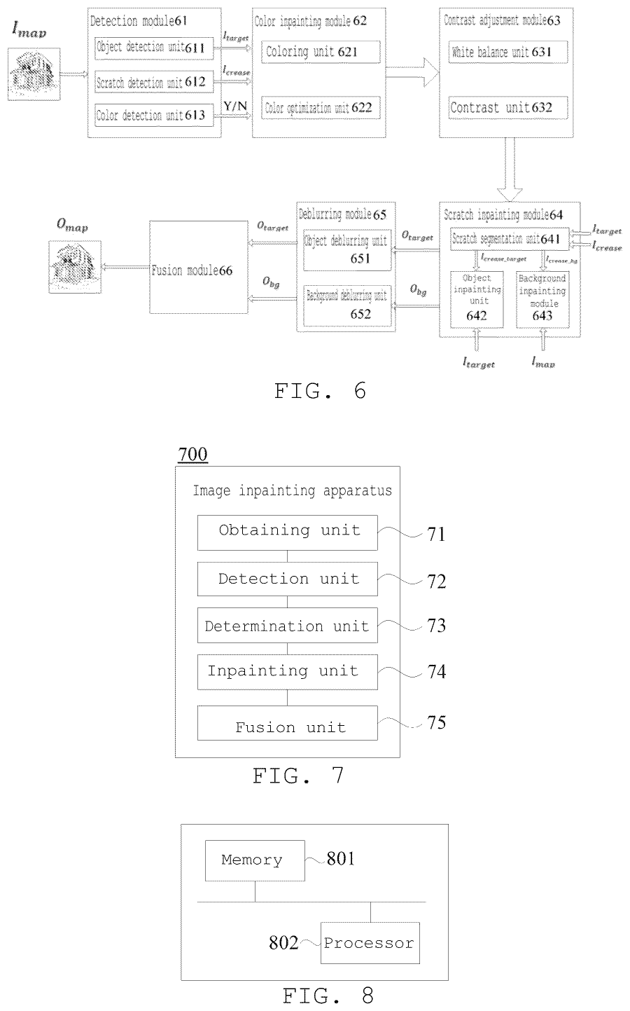

An embodiment of the present disclosure provides an image inpainting apparatus. FIG. 7 is a schematic structural diagram of the image inpainting apparatus. As shown in FIG. 7, the image inpainting apparatus 700 comprises:
an obtaining unit 71 configured to obtain an image to be inpainted;
a detection unit 72 configured to determine an object region and a scratch region of the image to be inpainted;
a determination unit 73 configured to determine an object scratch region and a background scratch region according to the object region and the scratch region;
an inpainting unit 74 configured to perform image inpainting on the object region according to the object scratch region to obtain an object image;
the inpainting unit 74 being further configured to perform image inpainting on the image to be inpainted according to the background scratch region to obtain a background image;
a fusion unit 75 configured to fuse the object image and the background image to obtain an inpainted image of the image to be inpainted.

As an implementation of the embodiment of the present disclosure, the determination unit 73 is specifically configured to obtain the object scratch region based on a segmentation network model and the object region, the segmentation network model being a network model obtained by training a U-Net (UNET) based on a first sample data, the first sample data including a plurality of sample images containing the target object and scratch regions corresponding to individual sample images; and determine the background scratch region according to the scratch region and the object scratch region.

As an implementation of the embodiment of the present disclosure, the inpainting unit 74 is specifically configured to input the object scratch region and the object region into a first image inpainting network model, and obtain output of the first image inpainting network model as the object image;
wherein, the first image inpainting network model is a network model obtained by training a first network model based on a second sample data, the second sample data including a plurality of sample object images with scratches and scratch-free images corresponding to individual sample object images.

As an implementation of the embodiment of the present disclosure, the inpainting unit 74 is specifically configured to input the background scratch region and the image to be inpainted into a second image inpainting network model, and obtain output of the second image inpainting network model as the background image;
wherein, the second image inpainting network model is a network model obtained by training a second network model based on a third sample data, the third sample data including a plurality of sample images with scratches and scratch-free images corresponding to individual sample images.

As an implementation of the embodiment of the present disclosure, the detection unit 72 is further configured to, after determining an object region and a scratch region of the image to be inpainted, determine whether the area of each scratch region is greater than or equal to a threshold area; and delete scratch regions with an area smaller than the threshold area from scratch regions of the image to be inpainted.

As an implementation of the embodiment of the present disclosure,
the detection unit 72 is further configured to, before segmenting the scratch region into an object scratch region and a background scratch region according to the object region, detect whether the image to be inpainted is a color image;
the inpainting unit 74 is further configured to color the image to be inpainted in response to the image to be inpainted being not a color image.

As an implementation of the embodiment of the present disclosure,
the detection unit 72 is further configured to, after coloring the image to be inpainted, determine an optimization region of the image to be inpainted, the optimization region being a region composed of pixels in the image to be inpainted whose color values fall within a preset color range;
the inpainting unit 74 is further configured to perform optimization on the optimization region based on a preset optimization algorithm.

As an implementation of the embodiment of the present disclosure, the inpainting unit 74 is further configured to, after coloring the image to be inpainted, perform white balance processing on the image to be inpainted based on a perfect reflector algorithm.

As an implementation of the embodiment of the present disclosure, the inpainting unit 74 is further configured to, after coloring the image to be inpainted, adjust the contrast of the image to be inpainted based on a high dynamic range imaging network model (HDRNET).

As an implementation of the embodiment of the present disclosure, the inpainting unit 74 is further configured to, before fusing the object image and the background image to obtain an inpainted image of the image to be inpainted, perform deblurring processing on the object image and the background image, respectively.

The log output device provided in this embodiment can execute the image inpainting method provided in the above method embodiment. Their implementation principles and technical effects are similar, which will not be repeated here.

Based on the same inventive concept, an embodiment of the present disclosure further provides an electronic device. FIG. 8 is a schematic structural diagram of an electronic device provided by an embodiment of the present disclosure. As shown in FIG. 8, the electronic device provided by the embodiment comprises: a memory 801 and a processor 802, wherein the memory 801 is configured to store a computer program; the processor 802 is configured to, when executing the computer program, execute the image inpainting method provided by the above embodiment.

Based on the same inventive concept, an embodiment of the present disclosure further provides a computer-readable storage medium having a computer program stored thereon, which, when executed by a processor, causes the computing device to implement the image inpainting method provided by the above embodiments.

Based on the same inventive concept, an embodiment of the present disclosure further provides a computer program product, which, when runs on a computer, causes the computing device to implement the image inpainting method provided in the above embodiments.

Those skilled in the art will appreciate that embodiments of the present disclosure may be provided as methods, systems, or computer program products. Thus, the present disclosure may take the form of an entirely hardware embodiment, an entirely software embodiment, or an embodiment combining software and hardware aspects. Furthermore, the present disclosure may take the form of a computer program product embodied on one or more computer-usable storage media having computer-usable program code contained therein.

The processor may be a Central Processing Unit (CPU), other general-purpose processor, a Digital Signal Processor (DSP), an Application Specific Integrated Circuit (ASIC), or a Field-Programmable Gate Array (FPGA) or other programmable logic device, a discrete gate or transistor logic device, a discrete hardware component, etc. A general-purpose processor may be a microprocessor or the processor may be any conventional processor, etc.

The memory may include the form of a non-persistent memory, a random access memory (RAM) and/or a non-volatile memory, etc. in computer-readable media, for example, a read-only memory (ROM) or a flash RAM. The memory is an example of computer-readable media.

The computer-readable media include persistent and non-persistent, removable and non-removable storage media. The storage media may be implemented by any method or technology to store information, and the information may be computer-readable instructions, data structures, program modules, or other data. Examples of computer storage media include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technology, a compact disc read-only memory (CD-ROM), a digital versatile disc (DVD) or other optical storage, a magnetic tape cassette, a magnetic disk storage or other magnetic storage devices or any other non-transmission medium, which can be used to store information that can be accessed by a computing device. The computer-readable media, as defined herein, exclude transitory media, such as modulated data signals and carrier waves.

Finally, it should be noted that the above embodiments are only used to illustrate the technical solutions of the present disclosure, but not to limit them; although the present disclosure has been described in detail with reference to the foregoing embodiments, those of ordinary skill in the art should understand that: the technical solutions recited in the foregoing embodiments can still be modified, or some or all of the technical features thereof can be equivalently substituted; and these modifications or substitutions do not make the essence of the corresponding technical solutions deviate from the range of the technical solutions of the embodiments of the present disclosure.

What is claimed is:

1. An image inpainting method, comprising:
obtaining an image to be inpainted;
determining an object region and a scratch region of the image to be inpainted, the object region being a region where a target object in the image to be inpainted is located;
determining an object scratch region and a background scratch region according to the object region and the scratch region;
performing image inpainting on the object region according to the object scratch region to obtain an object image;
performing image inpainting on the image to be inpainted according to the background scratch region to obtain a background image; and
fusing the object image and the background image to obtain an inpainted image of the image to be inpainted.

2. The method according to claim 1, wherein the determining an object scratch region and a background scratch region according to the object region and the scratch region includes:
obtaining the object scratch region based on a segmentation network model and the object region, the segmentation network model being a network model obtained by training a U-Net (UNET) based on first sample data, the first sample data including a plurality of sample images containing the target object and scratch regions corresponding to individual sample images; and
determining the background scratch region according to the scratch region and the object scratch region.

3. The method according to claim 1, wherein the performing image inpainting on the object region according to the object scratch region to obtaining an object image includes:
inputting the object scratch region and the object region into a first image inpainting network model, and obtaining output of the first image inpainting network model as the object image;
wherein, the first image inpainting network model is a network model obtained by training a first network model based on second sample data, the second sample data including a plurality of sample object images with scratches and scratch-free images corresponding to individual sample object images.

4. The method according to claim 1, wherein the performing image inpainting on the image to be inpainted according to the background scratch region to obtain a background image includes:
inputting the background scratch region and the image to be inpainted into a second image inpainting network model, and obtaining output of the second image inpainting network model as the background image;
wherein, the second image inpainting network model is a network model obtained by training a second network model based on third sample data, the third sample data including a plurality of sample images and scratch regions randomly generated for individual sample images.

5. The method according to claim 1, wherein after determining an object region and a scratch region of the image to be inpainted, the method further comprises:
determining whether the area of each scratch region is greater than or equal to a threshold area; and
deleting scratch regions with an area smaller than the threshold area from scratch regions of the image to be inpainted.

6. The method according to claim 1, wherein before segmenting the scratch region into an object scratch region and a background scratch region according to the object region, the method further comprises:
detecting whether the image to be inpainted is a color image;
in response to the image to be inpainted being not a color image, coloring the image to be inpainted.

7. The method according to claim 6, wherein after coloring the image to be inpainted, the method further comprises:
determining an optimization region of the image to be inpainted, the optimization region being a region composed of pixels in the image to be inpainted whose color values fall within a preset color range; and
performing optimization on the optimization region based on a preset optimization algorithm.

8. The method according to claim 6, wherein after coloring the image to be inpainted, the method further comprises:
performing white balance processing on the image to be inpainted based on a perfect reflector algorithm.

9. The method according to claim 6, wherein after coloring the image to be inpainted, the method further comprises:
adjusting the contrast of the image to be inpainted based on a high dynamic range imaging network model (HIDRNET).

10. The method according to claim 6, wherein before fusing the object image and the background image to obtain an inpainted image of the image to be inpainted, the method further comprises:
performing deblurring processing on the object image and the background image, respectively.

11. (canceled)

12. An electronic device, comprising: a memory and a processor, wherein the memory is configured to store a computer program; the processor is configured to, when executing the computer program, cause the electronic device to implement the following image inpainting operations:
obtaining an image to be inpainted;
determining an object region and a scratch region of the image to be inpainted, the object region being a region where a target object in the image to be inpainted is located;
determining an object scratch region and a background scratch region according to the object region and the scratch region;
performing image inpainting on the object region according to the object scratch region to obtain an object image;
performing image inpainting on the image to be inpainted according to the background scratch region to obtain a background image; and
fusing the object image and the background image to obtain an inpainted image of the image to be inpainted.

13. A computer-readable storage medium having a computer program stored thereon, which, when executed by a computing device, causes the computing device to implement the following image inpainting operations:
obtaining an image to be inpainted;
determining an object region and a scratch region of the image to be inpainted, the object region being a region where a target object in the image to be inpainted is located;
determining an object scratch region and a background scratch region according to the object region and the scratch region;
performing image inpainting on the object region according to the object scratch region to obtain an object image;
performing image inpainting on the image to be inpainted according to the background scratch region to obtain a background image; and
fusing the object image and the background image to obtain an inpainted image of the image to be inpainted.

14. (canceled)

15. The electronic device according to claim 12, wherein the determining an object scratch region and a background scratch region according to the object region and the scratch region includes:
obtaining the object scratch region based on a segmentation network model and the object region, the segmentation network model being a network model obtained by training a U-Net (UNET) based on first sample data, the first sample data including a plurality of sample images containing the target object and scratch regions corresponding to individual sample images; and
determining the background scratch region according to the scratch region and the object scratch region.

16. The electronic device according to claim 12, wherein the performing image inpainting on the object region according to the object scratch region to obtaining an object image includes:
inputting the object scratch region and the object region into a first image inpainting network model, and obtaining output of the first image inpainting network model as the object image;
wherein, the first image inpainting network model is a network model obtained by training a first network model based on second sample data, the second sample data including a plurality of sample object images with scratches and scratch-free images corresponding to individual sample object images.

17. The electronic device according to claim 12, wherein the performing image inpainting on the image to be inpainted according to the background scratch region to obtain a background image includes:
inputting the background scratch region and the image to be inpainted into a second image inpainting network model, and obtaining output of the second image inpainting network model as the background image;
wherein, the second image inpainting network model is a network model obtained by training a second network model based on third sample data, the third sample data including a plurality of sample images and scratch regions randomly generated for individual sample images.

18. The electronic device according to claim 12, wherein after determining an object region and a scratch region of the image to be inpainted, the processor is configured to, when executing the computer program, cause the electronic device to further implement the following operations:
determining whether the area of each scratch region is greater than or equal to a threshold area; and
deleting scratch regions with an area smaller than the threshold area from scratch regions of the image to be inpainted.

19. The storage medium according to claim 13, wherein the determining an object scratch region and a background scratch region according to the object region and the scratch region includes:
obtaining the object scratch region based on a segmentation network model and the object region, the segmentation network model being a network model obtained by training a U-Net (UNET) based on first sample data, the first sample data including a plurality of sample images containing the target object and scratch regions corresponding to individual sample images; and
determining the background scratch region according to the scratch region and the object scratch region.

20. The storage medium according to claim 13, wherein the performing image inpainting on the object region according to the object scratch region to obtaining an object image includes:
inputting the object scratch region and the object region into a first image inpainting network model, and obtaining output of the first image inpainting network model as the object image;
wherein, the first image inpainting network model is a network model obtained by training a first network model based on second sample data, the second sample data including a plurality of sample object images with scratches and scratch-free images corresponding to individual sample object images.

21. The storage medium according to claim 13, wherein the performing image inpainting on the image to be inpainted according to the background scratch region to obtain a background image includes:
inputting the background scratch region and the image to be inpainted into a second image inpainting network model, and obtaining output of the second image inpainting network model as the background image;
wherein, the second image inpainting network model is a network model obtained by training a second network model based on third sample data, the third sample data including a plurality of sample images and scratch regions randomly generated for individual sample images.

22. The storage medium according to claim 13, wherein after determining an object region and a scratch region of the image to be inpainted, the computer program, when executed by a computing device, causes the computing device to further implement the following operations:
determining whether the area of each scratch region is greater than or equal to a threshold area; and
deleting scratch regions with an area smaller than the threshold area from scratch regions of the image to be inpainted.
